(19) United States
(12) Patent Application Publication
(10) Pub. No.: US 2026/0172923 A1
(43) Pub. Date: Jun. 18, 2026

(54) PERFORMING AN INDIRECT TO DIRECT/INDIRECT LOSSLESS HANDOVER

(71) Applicant: INTERDIGITAL PATENT HOLDINGS, INC., Wilmington, DE (US)

(72) Inventors: Oumer TEYEB, Montreal (CA); Martino FREDA, Laval (CA); Paul MARINIER, Brossard (CA)

(73) Assignee: INTERDIGITAL PATENT HOLDINGS, INC., Wilmington, DE (US)

(21) Appl. No.: 19/127,037

(22) PCT Filed: Nov. 2, 2023
(86) PCT No.: PCT/US2023/078529

§ 371 Date: May 2, 2025

Related U.S. Application Data
(60) Provisional application No. 63/421,778, filed on Nov. 2, 2022.
(60) Provisional application No. 63/494,410, filed on Apr. 5, 2023.

(51) Int. Cl. H04W 36/02; H04W 36/08

(52) U.S. Cl. CPC H04W 36/0235; H04W 36/08

(57) ABSTRACT

Methods and devices are disclosed for reducing packet loss during WTRU handover from an indirect link with a source base station to a direct or indirect link with a target base station. A remote wireless transmit receive unit (WTRU) may, after HO to the target base station, receives a packet data convergence protocol (PDCP) status report/PDU from the target base station. The WTRU may retransmit PDCP packets in its PDCP buffer that are indicated as not received in the received PDCP status report, which include packets previously transmitted by the remote WTRU and acknowledged received by the source relay WTRU. Additional embodiments are disclosed.

### CROSS-REFERENCE TO RELATED APPLICATIONS

This application claims the benefit of U.S. Provisional Application No. 62/494,410, filed Apr. 5, 2023 and U.S. Provisional Application No. 63/421,778, filed Nov. 2, 2022, the contents of which are incorporated herein by reference.

### BACKGROUND

Vehicle-to-everything (V2X) communication technologies with capabilities for a wireless transmit receive unit (WTRU) to communicate with other devices is desirable. ProSe WTRU-to-Network relays have previously been introduced to extend network coverage to an out of coverage WTRU by using PC5 device-to-device (D2D) communications between an out of coverage WTRU and a WTRU-to-Network relay. When a remote WTRU performs a handover (HO) from an indirect link (i.e., connection via a SL relay WTRU), there can be some outstanding packets that are ACKed over the SL relay but still pending transmission over the backhaul link between the relay WTRU and the gNB. Thus, packet loss may occur during such HOs, as packets already ACKed by lower layers are not retransmitted when PDCP is re-established after the HO. Accordingly, there is a need for improved WTRU to network coverage extension and WTRU to WTRU coverage extension to ensure that there will be no UL or DL packet loss when a handover is performed from an indirect link via a source relay WTRU to a target direct or indirect link.

### SUMMARY

Embodiments of the present invention relate to WTRU relay and handover operations in next generation wireless networks such as 5G NR. More specifically, embodiments relate to reduction of UL and/or DL packet loss when a handover is performed between various network entities including remote WTRUs from an indirect link via a source relay WTRU to a target direct/indirect link.

Embodiments are disclosed for wireless communications in a 5G network having multiple relay configurations accommodating indirect and direct packet flow switching for various handover (HO) scenarios with reduced packet loss and increased efficiencies. In an example downlink transmission from a base station, e.g., a gNB, to a remote wireless transmit and receive unit (WTRU) via an indirect connection/link with a source relay WTRU, the HO flows may involve the source relay WTRU buffering packets and delaying acknowledgements (ACKs) to the gNB until after an ACK for a related packet has been received from the remote WTRU via the sidelink. Similar buffering and delaying ACKs may be performed in the uplink. Delaying transmissions of ACKs may only be temporary, e.g., based on indicators, time periods before or after HO and/or based on conditional handover (CHO) triggers. Retransmissions of packets may be initiated based on a status PDU received only after HO from indirect to direct links.

According to certain aspects, a relay WTRU, upon receiving an indication (from the network or remote WTRU), may start to delay the sending of radio link control (RLC) ACKs to a remote WTRU until the ACK for the corresponding UL RLC packet is received over the Uu interface from the gNB. The relay WTRU, upon receiving an indication (from the network or remote WTRU), may stop the delaying of ACKs for UL RLC packets to the remote WTRU.

In other aspects, the relay WTRU, upon receiving an indication (from the network or remote WTRU), may start to delay the sending of RLC ACKs to the gNB until the ACK for the corresponding DL RLC packet is received over the sidelink (SL) from the remote WTRU. The relay WTRU, upon receiving an indication (from the network or remote WTRU), may stop the delaying of ACKs for DL RLC packets to the gNB.

According to further aspects of the embodiments, a remote WTRU may be configured with a condition to send an indication to the relay WTRU to start delaying UL/DL RLC ACKs (e.g., a trigger condition associated with a conditional handover (CHO) which is used to trigger the sending of the delaying indication, before the legacy CHO trigger condition to execute the CHO).

In additional aspects, a remote WTRU, upon receiving a packet data convergence protocol (PDCP) status packet data unit (PDU), also referred to herein as a PDCP status report, indicating that a particular packet is not received, may begin retransmitting the packet immediately. The remote WTRU is configured to retransmit packets that have been indicated as not received in a PDCP status PDU received after a HO from an indirect link to a direct/indirect link. The remote WTRU may further be configured to apply this behavior on the reception of the first PDCP status PDU after a handover (HO) (e.g., within a given time) or reception of a status PDU with an explicit indication to retransmit the packets. The retransmission of packets by the remote WTRU may include packets in its PDCP buffer that have already been transmitted and acknowledged as received by a source relay WTRU prior to HO. Additional aspects of the embodiments are disclosed.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is an exemplary diagram of a sequence for WTRU/WTRU handover between network stations;

FIG. 3 is an example representation of a User Plane protocol stack for Layer 2 (L2 ) WTRU-to-Network Relay;

FIG. 4 is an example representation of a Control plane protocol stack for L2 WTRU-to-Network Relay;

FIG. 5 is an sequence diagram representing a procedure for user equipment-to-network (U2N) Remote WTRU switching to direct Uu cell;

FIG. 6 is an example message sequence for U2N Remote WTRU switching to indirect path;

FIG. 7 is a functional diagram representing a physical downlink convergence protocol (PDCP) layer functional view between WTRUs and next generation radio access network (NG-RAN);

FIG. 8 is an example diagram of entities in an inter-gNB indirect-to-indirect path switching scenario and related links;

FIG. 9 is an example messaging sequence for entities depicted in FIG. 8;

FIG. 10 is an example PDCP buffer at the remote WTRU where the Nx represent PDCP PDU sequence numbers;

FIG. 11 is an example flow diagram detailing a method for a remote WTRU performing lossless handover according to one embodiment; and

FIG. 12 is a message sequence diagram detailing message exchange and operation according to an embodiment.

### DETAILED DESCRIPTION

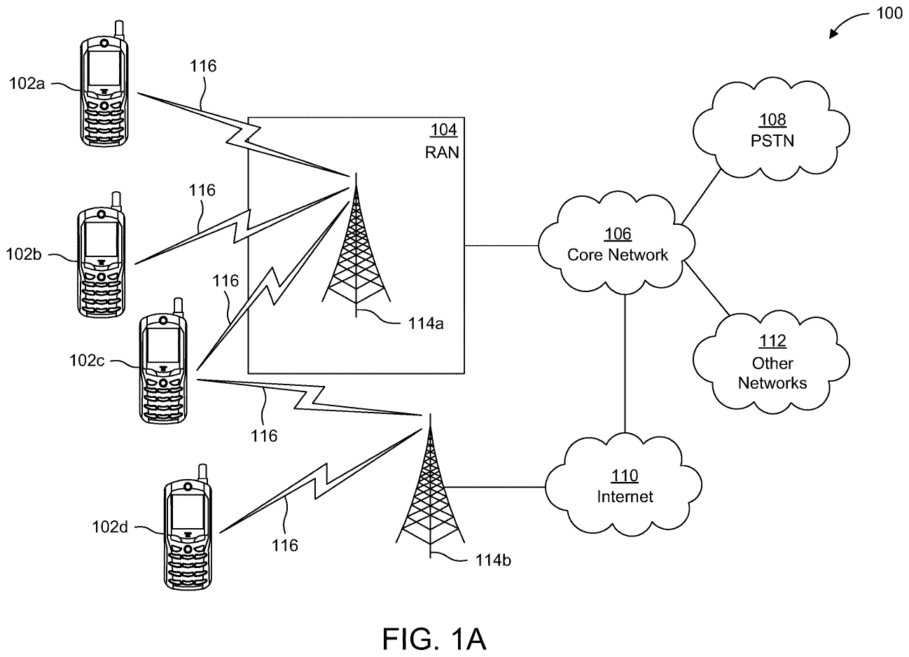

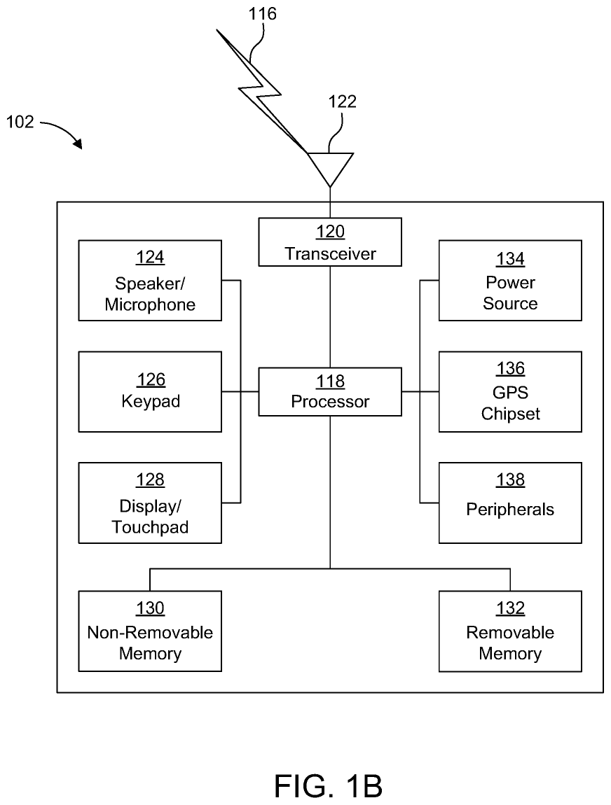

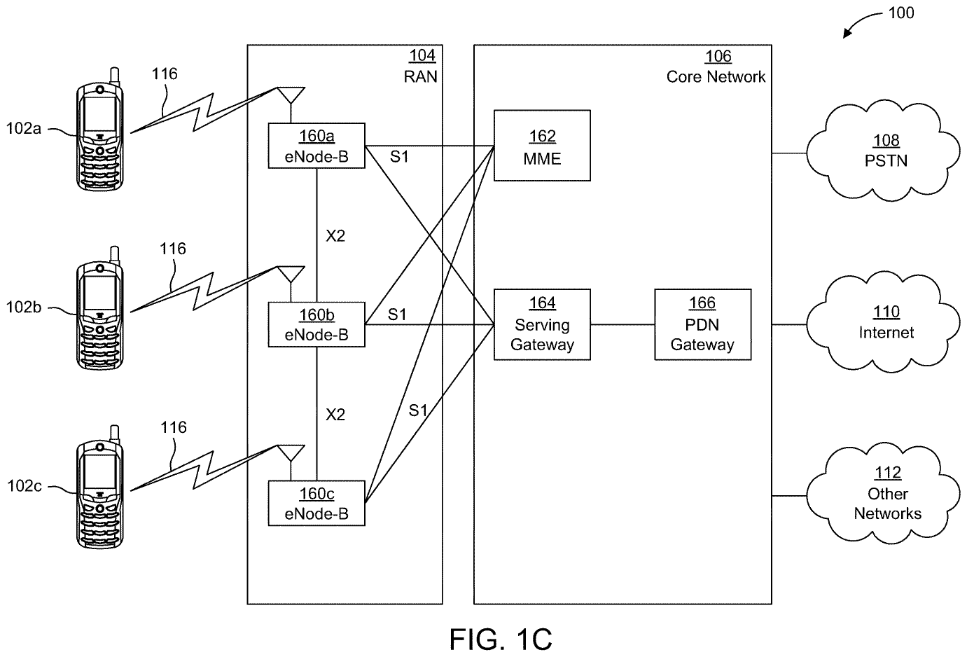

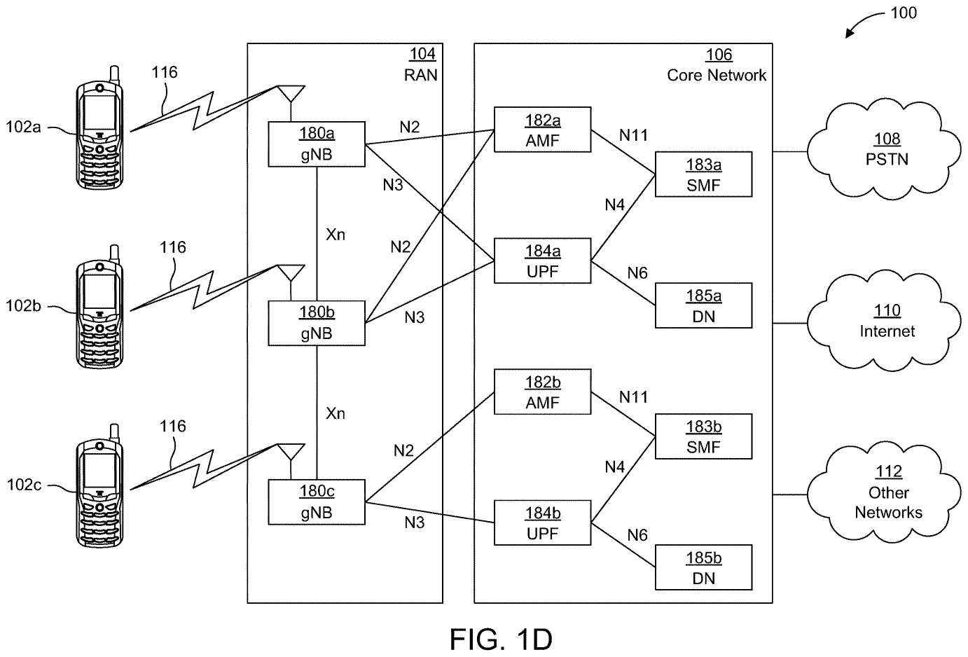

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80 +80 configuration. For the 80 +80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QOS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

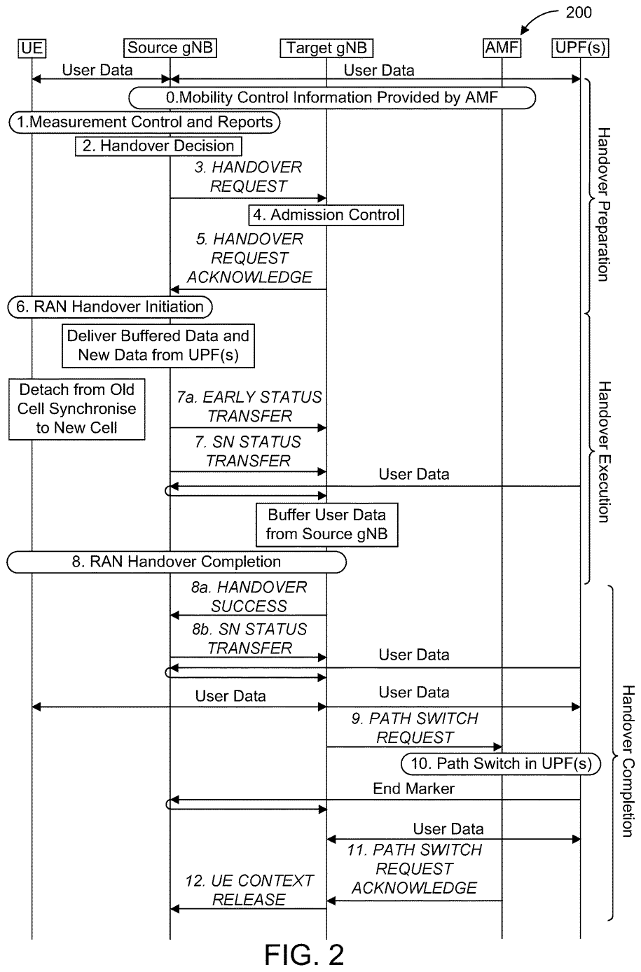

Referring to FIG. 2, an example handover process 200 between a WTRU and network access stations such as a source gNB and a target gNB is shown. At step 0, connection and session management information is exchanged between network nodes and controlled via an access and mobility management function (AMF). In one 5G network architecture, a user plane function (UPF) is responsible for packet routing and forwarding, packet inspection, QoS handling, and external PDU session for interconnecting Data Network (DN) (not shown). At step 1, the source gNB configures the WTRU measurement procedures and the WTRU reports according to the measurement configuration. At step 2, the source gNB decides whether to handover the WTRU, based on the received measurements, and if so, at step 3, the source gNB issues a Handover Request message to the target gNB passing a transparent radio resource control (RRC) container with necessary information to prepare the handover at the target side. The information may include at least the target cell ID, KgNB* (an intermediary key for horizontal or vertical security key derivation), the cell radio network temporary identifier (C-RNTI) of the WTRU in the source gNB, radio resource management (RRM)-configuration including WTRU inactive time, basic AS-configuration including antenna Info and DL Carrier Frequency, the current QoS flow to data radio bearer (DRB) mapping rules applied to the WTRU, the system information block (SIB1) from source gNB, the WTRU capabilities for different RATs, PDU session related information, and can include the WTRU reported measurement information including beam-related information if available.

At step 4, Admission Control may be performed by the target gNB and if the WTRU can be admitted; at step 5, the target gNB prepares the handover with L1/L2 and sends the HANDOVER REQUEST ACKNOWLEDGE to the source gNB, which includes a transparent container to be sent to the WTRU as an RRC message to perform the handover.

At step 6, the source gNB triggers the Uu handover by sending an RRCReconfiguration message to the WTRU, containing the information required to access the target cell: at least the target cell ID, the new C-RNTI, the target gNB security algorithm identifiers for the selected security algorithms. It can also include a set of dedicated random access control channel (RACH) resources, the association between RACH resources and SSB(s), the association between RACH resources and WTRU-specific CSI-RS configuration(s), common RACH resources, and system information of the target cell, etc. Next, at step 7, the source gNB may send the SN STATUS TRANSFER message to the target gNB to convey the uplink packet data convergence protocol (PDCP) SN receiver status and the downlink PDCP SN transmitter status of DRBs for which PDCP status preservation applies (i.e., for RLC AM). The WTRU may synchronize to the target cell and complete the RRC handover procedure, at step 8, by sending RRCReconfigurationComplete message to target gNB. At step 9, the target gNB may send a PATH SWITCH REQUEST message to the AMF to trigger the 5GC to switch the DL data path towards the target gNB and to establish an NG-C interface instance towards the target gNB. The 5GC switches the DL data path towards the target gNB at step 10. The UPF sends one or more “end marker” packets on the old path to the source gNB per PDU session/tunnel and then can release any U-plane/TNL resources towards the source gNB.

At step 11, the AMF confirms the PATH SWITCH REQUEST message with the PATH SWITCH REQUEST ACKNOWLEDGE message and at step 12, upon reception of the PATH SWITCH REQUEST ACKNOWLEDGE message from the AMF, the target gNB sends the WTRU CONTEXT RELEASE to inform the source gNB about the success of the handover. The source gNB can then release radio and C-plane related resources associated to the WTRU context. Any ongoing data forwarding may continue.

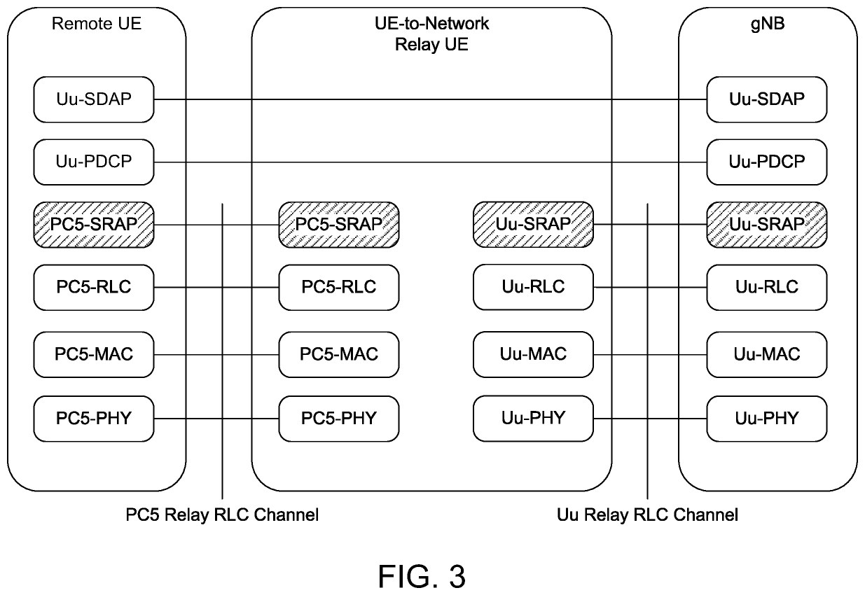

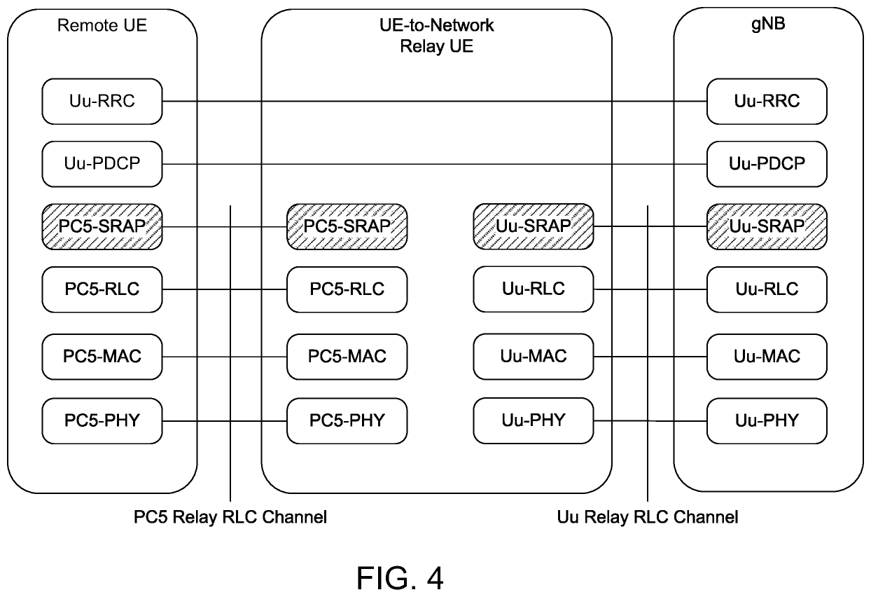

Referring to FIGS. 3 and 4, examples of protocol stacks for the respective user plane (FIG. 3) and control plane (FIG. 4) of L2 U2N Relay architecture are presented. The Sidelink Relay Adaptation Protocol (SRAP) sublayer may be placed above the RLC sublayer for both control plane (CP) and user plane (UP) at both PC5 interface and Uu interface. The Uu SDAP, PDCP and RRC may be terminated between L2 U2N Remote WTRU and gNB, while SRAP, RLC, MAC and PHY are terminated in each hop (i.e. the link between L2 U2N Remote WTRU and L2 U2N Relay WTRU and the link between L2 U2N Relay WTRU and the gNB).

For L2 U2N Relay, the SRAP sublayer over PC5 hop is for the purpose of bearer mapping. The SRAP sublayer is not present over PC5 hop for relaying the L2 U2N Remote WTRU's message on the broadcast control channel (BCCH) and paging control channel (PCCH). For L2 U2N Remote WTRU's message on SRB0, the SRAP sublayer is not present over PC5 hop, but the SRAP sublayer is present over Uu hop for both DL and UL.

For L2 U2N Relay, for uplink, in one example embodiment, the Uu SRAP sublayer supports UL bearer mapping between ingress PC5 Relay RLC channels for relaying and egress Uu Relay RLC channels over the L2 U2N Relay WTRU Uu interface. For uplink relaying traffic, the different end-to-end resource blocks (RBs) (e.g., signaling (SRBs) or data (DRBs)) of the same Remote WTRU and/or different Remote WTRUs can be multiplexed over the same Uu Relay RLC channel.

The Uu SRAP sublayer may support L2 U2N Remote WTRU identification for the UL traffic. The identity information of L2 U2N Remote WTRU Uu Radio Bearer and a local Remote WTRU ID may be included in the Uu SRAP header at UL in order for gNB to correlate the received packets for the specific PDCP entity associated with the right Uu Radio Bearer of a Remote WTRU. Further, the PC5 SRAP sublayer at the L2 U2N Remote WTRU may support UL bearer mapping between Remote WTRU Uu Radio Bearers and egress PC5 Relay RLC channels.

For L2 U2N Relay, for downlink, in an example embodiment, the Uu SRAP sublayer may support DL bearer mapping at the gNB to map end-to-end Radio Bearers (SRB, DRB) of the Remote WTRU into a Uu Relay RLC channel over Relay WTRU Uu interface. The Uu SRAP sublayer may support DL bearer mapping and data multiplexing between multiple end-to-end Radio Bearers (SRBs or DRBs) of a L2 U2N Remote WTRU and/or different L2 U2N Remote WTRUs and one Uu Relay RLC channel over the Relay WTRU Uu interface. The Uu SRAP sublayer may support Remote WTRU identification for DL traffic. The identity information of the Remote WTRU Uu Radio Bearer and a local Remote WTRU ID may be included into the Uu SRAP header by the gNB at DL in order for the Relay WTRU to map the received packets from Remote WTRU Uu Radio Bearer to its associated PC5 Relay RLC channel. Additionally, in one example, the PC5 SRAP sublayer at the Relay WTRU may supports DL bearer mapping between ingress Uu Relay RLC channels and egress PC5 Relay RLC channels. Further, the PC5 SRAP sublayer at the Remote WTRU can correlate the received packets for the specific PDCP entity associated with the correct Uu Radio Bearer of a Remote WTRU based on the identity information included in the Uu SRAP header.

In various embodiments, a local Remote WTRU ID may be included in both the PC5 SRAP header and the Uu SRAP header. L2 U2N Relay WTRU is configured by the gNB with the local Remote WTRU ID to be used in SRAP header. Remote WTRU may obtain the local Remote ID from the gNB via Uu RRC messages including RRCSetup, RRCReconfiguration, RRCResume and RRCReestablishment. Uu DRB(s) and Uu SRB(s) may be mapped to different PC5 Relay RLC channels and Uu Relay RLC channels in both PC5 hop and Uu hop.

In various embodiments, it is the gNB's responsibility to avoid collision on the usage of local Remote WTRU ID. The gNB can update the local Remote WTRU ID by sending the updated local Remote ID via RRCReconfiguration message to the Relay WTRU. The serving gNB can perform local Remote WTRU ID update independent of the PC5 unicast link L2 ID update procedure.

Service continuity with SL relay: Some support of service continuity in the context of sidelink (SL) relay may be supported (within the same gNB). Specifically, examples of WTRU switching communication links (or paths) between: (i) an indirect link/path, to a direct link and/or (ii) from a direct link/path to an indirect link, may be supported in various embodiments. For clarification, it is noted that an “indirect” link or path generally references that a remote WTRU utilizes a relay WTRU for connectivity to gNB.

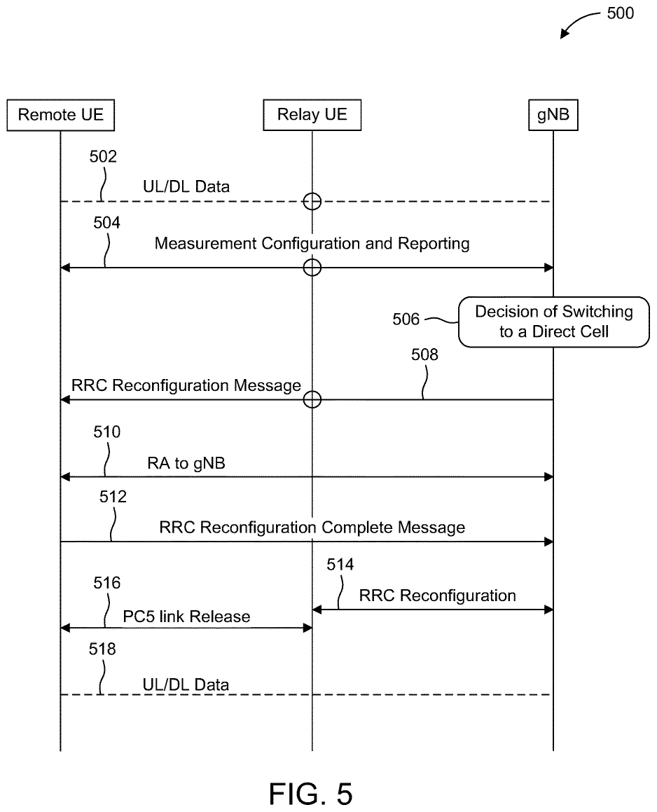

Referring to FIG. 5, a method 500 of WTRU Indirect to Direct Link Switching is shown. An interchange sequence between entities for WTRU switching packet flows from indirect to direct path to gNB is shown and described. For service continuity of L2 U2N Relay, the following procedure may be used in the case of the U2N Remote WTRU switching to direct path.

As shown, at 502, data flows between the remote WTRU to the gNB via an indirect link through relay WTRU. Uu measurement configuration and measurement report signaling procedures 504 may be performed to evaluate both relay link measurement and Uu link measurement. The measurement results from the WTRU to Network (U2N) Remote WTRU are reported when configured measurement reporting criteria are met. The sidelink relay measurement report 504 may include at least U2N Relay WTRU's source L2 ID, serving cell ID (i.e., NCGI), and sidelink measurement quantity information. The sidelink measurement quantity can be sidelink reference signal received power (SL-RSRP) of the serving U2N Relay WTRU, and if SL-RSRP is not available, SD-RSRP is used. At 506, the gNB decides to switch the U2N Remote WTRU onto a direct Uu path. At 508, the gNB sends RRCReconfiguration message to the U2N Remote WTRU and the U2N Remote WTRU may stop UP and CP transmission via U2N Relay WTRU, after reception of RRCReconfiguration message 508 from the gNB.

Next, the U2N Remote WTRU synchronizes with the gNB and performs Random Access 510. The WTRU (i.e., U2N Remote WTRU in previous steps) may send the RRCReconfigurationComplete 512 to the gNB via a direct path, using the configuration provided in the RRCReconfiguration message. From this step, the WTRU (i.e., U2N Remote WTRU in previous steps) uses the RRC connection via the direct path to the gNB.

The gNB may send a RRCReconfiguration message 514 to the U2N Relay WTRU to reconfigure the connection between the U2N Relay WTRU and the gNB. The RRCReconfiguration message 514 to the U2N Relay WTRU can be sent any time after step 508 based on gNB implementation (e.g., to release Uu and PC5 Relay RLC channel configuration for relaying, and bearer mapping configuration between PC5 RLC and Uu RLC).

Next, either the U2N Relay WTRU or the U2N Remote WTRU can initiate a PC5 unicast link release (PC5-S) 516. The timing to execute link release 516 may be up to WTRU implementation. The U2N Relay WTRU can execute PC5 connection reconfiguration to release PC5 Relay RLC channel for relaying upon reception of RRC Reconfiguration by gNB in 514, or the WTRU (i.e., previously the U2N Remote WTRU) can execute PC5 connection reconfiguration to release PC5 Relay RLC channel for relaying upon reception of RRCReconfiguration by gNB in 508.

The data path 518 is switched from indirect path to direct path between the WTRU (i.e., previously the U2N Remote WTRU) and the gNB, i.e., not requiring the relay WTRU. The DL/UL lossless delivery during the path switch may be performed according to a PDCP data recovery procedure. It should be recognized that step 518 might be performed at any time after step 510 and therefore may be independent of steps 514 and 516.

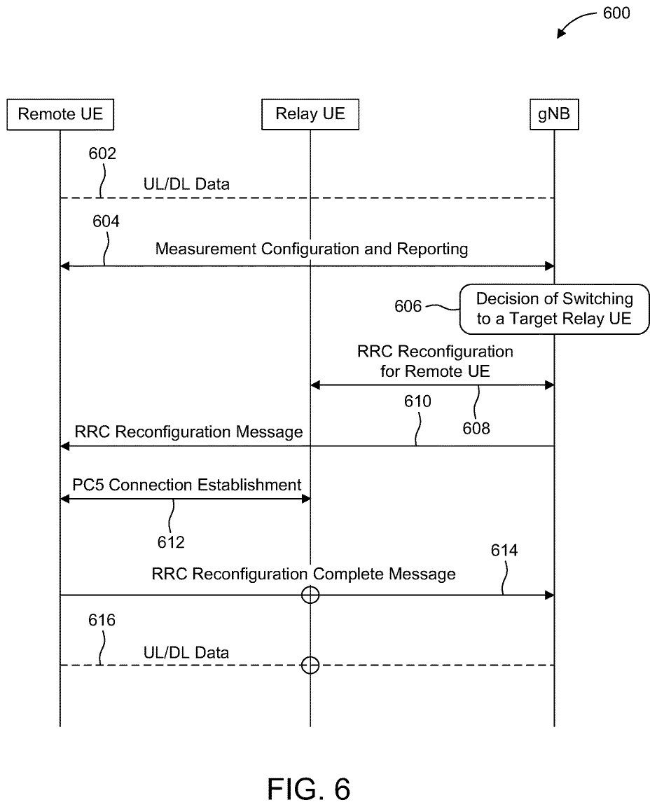

Referring to FIG. 6, a method 600 of WTRU Direct to Indirect Link Switching, an example interchange sequence between entities for WTRU switching packet flows from direct to indirect path to the gNB with service continuity is shown and described. In various embodiments, the gNB can select a U2N Relay WTRU in any RRC state i.e., RRC_IDLE, RRC_INACTIVE, or RRC_CONNECTED, as a target U2N Relay WTRU for direct to indirect path switch. For service continuity of the L2 U2N Remote WTRU, the following procedure 600 may be used in case of the L2 U2N Remote WTRU switching to indirect path via a U2N Relay WTRU in RRC_CONNECTED:

In the example of FIG. 6, a WTRU (designated as Remote UE) may be sending or receiving data 602 directly to the gNB. The WTRU may report 604 one or multiple candidate U2N Relay WTRU(s) and Uu measurements and after it measures/discovers the candidate U2N Relay WTRU(s). In one embodiment, the WTRU may filter the appropriate U2N Relay WTRU(s) according to, for example, Relay selection criteria before reporting 604. For example, the WTRU may report 604 only the U2N Relay WTRU candidate(s) that fulfil certain higher layer criteria. In certain embodiments, the reporting 604 can include a U2N Relay WTRU ID, U2N Relay WTRU's serving cell ID, and sidelink measurement quantity information. The sidelink measurement quantity can be SL-RSRP of the candidate U2N Relay WTRU, and if SL-RSRP is not available, SD-RSRP is used.

Next, the gNB may decide to switch 606 the direct link with the WTRU to a target U2N Relay WTRU. If so, the gNB sends an RRCReconfiguration message 608 to the target U2N Relay WTRU, which can preferably include a Remote WTRU's local ID and L2 ID, Uu and PC5 Relay RLC channel configuration for relaying, and bearer mapping configuration.

The gNB may send the RRCReconfiguration message 610 to the U2N Remote WTRU. In one embodiment, the contents in the RRCReconfiguration message 610 can include a U2N Relay WTRU ID, PC5 Relay RLC channel configuration for relay traffic and the associated end-to-end radio bearer(s). The U2N Remote WTRU may stop UP and CP transmission over Uu after reception of RRCReconfiguration message 610 from the gNB.

The WTRU may then establish a PC5 /D2D connection 612 with the target U2N Relay WTRU. The U2N Remote WTRU may complete the path switch procedure by sending the RRCReconfigurationComplete message 614 to the gNB via the Relay WTRU. The data path is the switched 616 from direct path between the U2N Remote WTRU and the gNB to indirect path via the Relay WTRU.

In cases in which the selected U2N Relay WTRU for direct to indirect path switch is in RRC_IDLE or RRC_INACTIVE mode, after receiving the path switch command, the U2N Remote WTRU establishes a PC5 link with the U2N Relay WTRU 612 and sends the RRCReconfigurationComplete message 614 via the U2N Relay WTRU, which will trigger the U2N Relay WTRU to enter RRC_CONNECTED state. The procedure for U2N Remote WTRU switching to indirect path in FIG. 6 can be also applied for the case that the selected U2N Relay WTRU for direct to indirect path switch is in RRC_IDLE or RRC_INACTIVE where step 612 is performed before step 608 if desired.

3GPP has agreed to continue enhancements of the NR SL relay specification in Rel-18, where scenarios for service continuity are expanded. Study items include specifying mechanisms to enhance service continuity for single-hop Layer-2 WTRU-to-Network relay for the following scenarios for RAN 2 and RAN3 work groups:
A.) Inter-gNB indirect-to-direct path switching (i.e., “remote WTRU <-> relay WTRU A <-> gNB X” to “remote WTRU <-> gNB Y”);
B.) Inter-gNB direct-to-indirect path switching (i.e., “remote WTRU <-> gNB X” to “remote WTRU <-> relay WTRU A <-> gNB Y”);
C.) Intra-gNB indirect-to-indirect path switching (i.e., “remote WTRU <-> relay WTRU A <-> gNB X” to “remote WTRU <-> relay WTRU B <-> gNB X”); and
D.) Inter-gNB indirect-to-indirect path switching (i.e., “remote WTRU <-> relay WTRU A <-> gNB X” to “remote WTRU <-> relay WTRU B <-> gNB Y”)

The last scenario (D) may be supported by using solutions for the other scenarios without specific optimizations.

In various embodiments, the PDCP layer provides its services to the RRC (in CP) or SDAP (in UP) layers. PDCP may provide the following functionalities:
transfer of data (user plane or control plane);
maintenance of PDCP Sequence Numbers (SNs);
header compression and decompression
security (ciphering and integrity protection during transmission and deciphering and integrity verification during reception)
timer based SDU discard;
duplication;
reordering and in-order delivery;
out-of-order delivery;

### Duplicate Discarding.

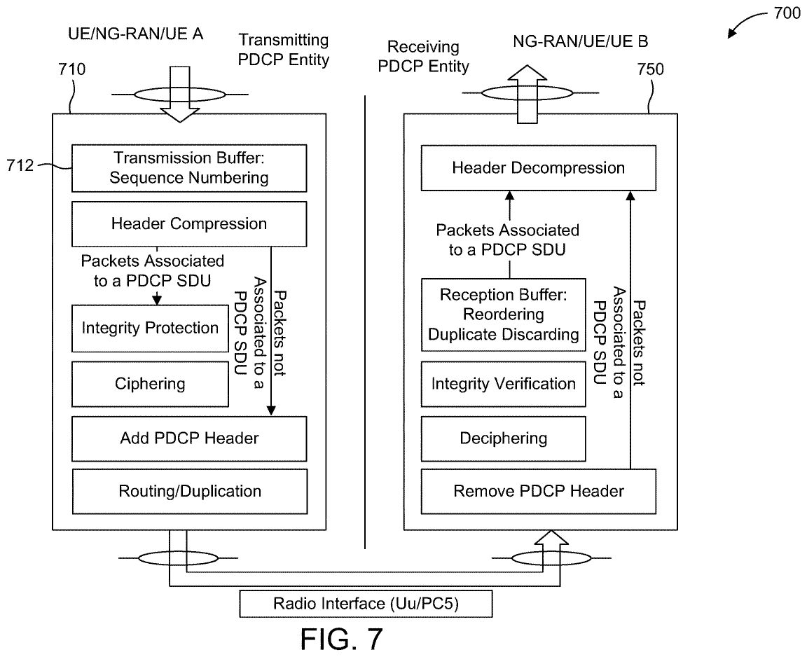

Referring to FIG. 7 shows a logical diagram 700 of PDCP entities for a relay WTRU. In certain embodiments, there may be a PDCP entity 710, 750 associated with each radio bearer (SRB or DRB) and it has a transmitting entity 710 and a receiving entity 750.

A PDCP entity associated with a DRB may be configured with a discardTimer or some other way of measuring a discard time period. This timer specifies the maximum amount of time packets are held in the transmit buffer. That is, whenever a new packet is received from upper layers, a new time period with a value of equal to the discardTimer is started. When the discard Time period expires for a PDCP service data unit (SDU), or the successful delivery of a PDCP SDU is confirmed by the reception of a PDCP status report, the transmitting PDCP entity 710 will discard the PDCP SDU along with the corresponding PDCP Data PDU.

Thus, even after the PDCP SDU is transferred to the RLC for transmission, the packet may be kept at the PDCP transmit buffer 712. This can actually be useful for failure recovery cases, such as re-establishment after a radio link failure (RLF). In such cases, a WTRU may re-establish the PDCP entity, which may result in the transmission of the SDUs that are still in the PDCP transmit buffer 712.

When upper layers request a PDCP entity re-establishment, the transmitting PDCP entity 710 will, for UM DRBs and AM DRBs, reset the robust header compression (ROHC) protocol for uplink and start with an IR state in U-mode if drb-ContinueROHC is not configured.

During HO, a WTRU may receive an indication to re-establish the PDCPs of one or more of its bearers. This is indicated to the WTRU in the RRCReconfiguration message (i.e., the HO command) by including the reestablish PDCP IE (information element) for each concerned DRB or SRB configuration (e.g., in the DRB-ToAddMod or SRB-ToAddMod IEs included in the RadioBearerConfig).

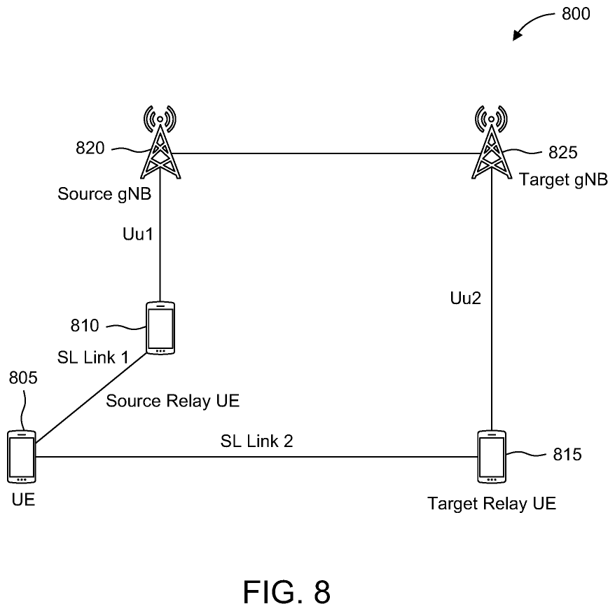

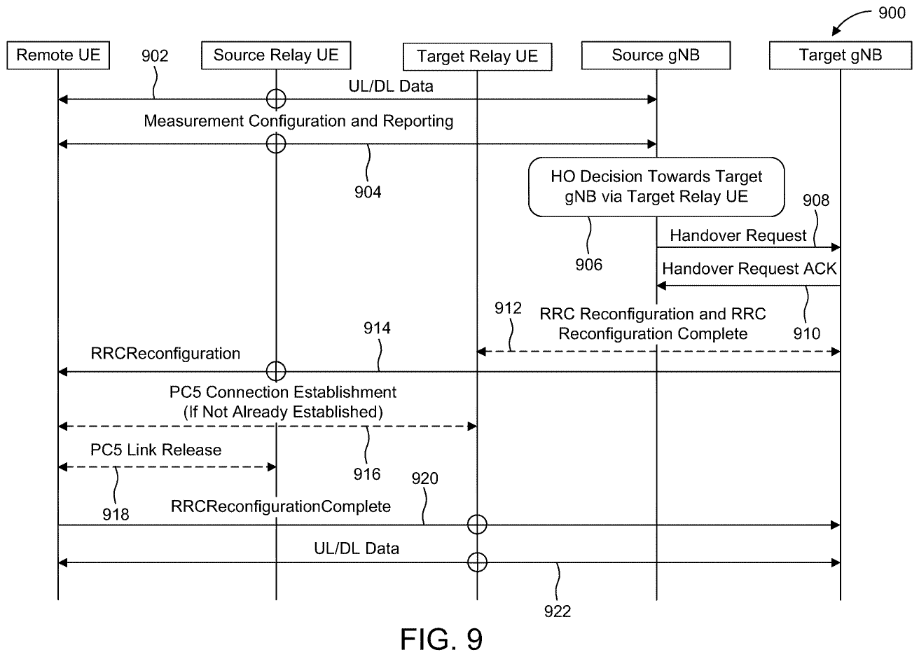

Consider an inter-gNB indirect-to-indirect path switching as shown in examples in reference to FIGS. 8-10. FIG. 8 shows an example network architecture 800 showing a remote WTRU 805 performing a handover from relay WTRU 810 to target relay WTRU 815 (i.e., HO from indirect link with source gNB 820 to indirect link with target gNB 825). FIG. 9 shows a corresponding method 900 for indirect link to indirect link handover. Initially, the remote WTRU is communicating 902 with a source gNB via an indirect link through the source relay WTRU. After measurement and reporting 904, the source gNB may determine 906 a handover should be made to a target gNB via a target relay WTRU. The source gNB and target gNB confirm the handover using HO request message 908 and acknowledgement message 910. The RRC of the target relay WTRU is updated via messaging 912 and RRC of the source relay WTRU and remote WTRU is updated for the HO via messaging 914. Handover is completed to the target relay WTRU and target gNB via messaging 916-922.

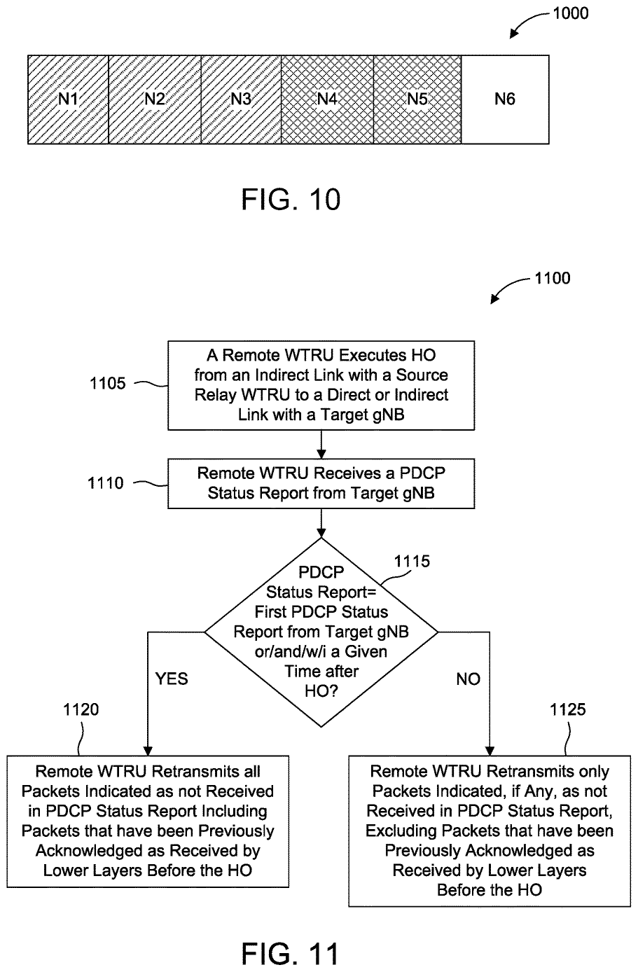

Referring to FIG. 10, an example buffer 1000 of the remote WTRU is shown. Assume that by the time the HO command was received at the remote WTRU (i.e., messaging 914 in FIG. 9), the PDCP buffer at the remote WTRU looks like example buffer 1000 shown in FIG. 10 (where the N(x), where x=1-6, represents PDCP PDU sequence numbers). Assuming the following in reference to FIG. 10: (i) some or all of the RLC packets corresponding to N6 are pending transmission between the remote WTRU and source relay WTRU, (ii) all the RLC packets corresponding to packets N1 to N5 were received at the source relay WTRU, (iii) all the RLC packets corresponding to packets N1 to N3 were received at the source gNB, and (iv) some or all of the RLC packets corresponding to N4 and N5 were not received at the source gNB (i.e., pending transmission between the source relay WTRU and source gNB).

From the remote WTRUs point of view, N1 to N5 have already been successfully transmitted, as they are all ACKed at RLC level by the source relay WTRU. Thus, when the remote WTRU receives the HO command, which typically contains an indication to re-establish the PDCP of the bearers, the remote WTRU will not be able to see a difference about the status of the packets N1-N3 and N4-N5, and will only retransmit N6 towards the target, as that is the only packet that has not been ACKed at RLC level by the source relay WTRU.

If the source relay WTRU and source gNB still have a good connection to one another, the RLC packets corresponding to N4 and N5 will end up being received by the source gNB, which may then forward them to the target gNB. However, this may not be possible or desirable for several reasons, for example, (i) the HO of the remote WTRU may have been triggered due to an issue on the Uu link between the source relay WTRU and source gNB (e.g., RLF, congestion, very low signal levels, etc.); (ii) by the time the packets get received at the source gNB, the source gNB may have already released the WTRU context or has released the Xn tunnels towards the target gNB for forwarding the packets (i.e., HO was considered finished by the source gNB); (iii) even if the forwarding was possible, these packets may be received out of order (e.g., N6 may have been received earlier at the target gNB), which may cause performance issues at the application layer (e.g., TCP may trigger transmit/receive window reduction, and hence throughput penalty, as it may assume the out of order reception as an indication of packet loss); and/or (iv) if in-order delivery was configured on the gNB side, there could be interruption of UL data while the target gNB is waiting for the missing packets.

The scenario is similar in the DL direction. That is, the RLC packets corresponding to the PDCP packets sent by the source gNB may have been ACKed by the source relay WTRU, but they may be pending transmission over the sidelink towards the remote WTRU. The network could solve this to some extent via implementation. For example, in one embodiment, the source gNB keeps the packets in its transmission buffer for an extended period of time (e.g., set longer discard timers). Alternatively or in addition, when the target gNB gets the PDCP status report from the WTRU during the HO (which is triggered by the WTRU when it receives the PDCP re-establishment indication in the HO command), it will identify the missing packets. Furthermore, the target gNB may request the source gNB to send these missing packets.

However, these options may be inefficient as they may impose large buffer size requirements at the gNBs and the packet reordering problem described for the UL case may still exist (e.g., target gNB have already forwarded to the WTRU a packet with a higher SN to the remote WTRU before receiving these missing packets, so the WTRU's application layer, e.g., TCP, may have overreacted by reducing the receive window size). Even if in-order delivery was configured at the WTRU, the problem may be mitigated, but at a cost of service interruption for a certain time while the WTRU waits for the missing packets, which actually may have been in vain as these missing packets may never arrive.

Further embodiments providing more desirable results are described, for example, in reference to the example of FIG. 11. Here, as with architecture 800 of FIG. 8 and method 900 of FIG. 9, HO is performed from an indirect link towards a source gNB to a direct or indirect link towards another gNB. It is worthy of recognizing that the various solutions may be applicable to other scenarios such as: Inter-gNB indirect to direct HO; Intra-gNB indirect to direct HO; Intra-gNB indirect to indirect HO and/or other relaying scenarios such as integrated access backhaul (IAB) network

In the following example embodiments, the term sidelink (SL) is mainly used to refer to a PC5 interface between a relay WTRU and the remote WTRU. However, all the solutions are equally applicable to other possible interfaces between the remote WTRU and the relay WTRU, such as a proprietary interface, wired interface, etc. Moreover, the embodiments are also applicable to the case of conditional handover, where the remote WTRU is preconfigured with a HO command and applies it upon the fulfillment of some trigger conditions (e.g., radio conditions towards a target link are better than a source link by a certain threshold/margin).

Scenarios for a relay WTRU Delaying Sending SL RLC ACKs until Reception Over the Backhaul Uu are discussed herein. In one embodiment, the relay WTRU sends an RLC ACK over the SL only when the corresponding RLC packet is ACKed by the gNB over the backhaul Uu. In a first example embodiment, the relay WTRU applies this behavior for all RLC packets/channels. In another example embodiment the relay WTRU applies this behavior only for certain RLC channels (e.g., pre-configured by the gNB when the indirect path is setup).

In yet another example embodiment, the relay WTRU applies this behavior depending on the radio link conditions over the backhaul Uu or/and the radio link conditions (or congestion) over the SL towards the remote WTRU. For example, the relay WTRU may apply legacy behavior (i.e., send the RLC ACKs over the SL without waiting for their reception over the backhaul Uu) when the backhaul Uu signal level is equal to or above a certain threshold, and apply the new behavior (i.e., wait until the reception over backhaul Uu before sending the RLC ACKs over the SL) when the backhaul Uu signal level is below the threshold. According to these example embodiments, a variant solution may include the relay WTRU being configured to apply different signal level thresholds (e.g., for the backhaul Uu, for the SL, etc.) or congestion thresholds for the SL, for different RLC channels.

In another example embodiment, the relay WTRU may be configured with a maximum time to wait for the ACKs over the backhaul Uu before sending the ACKs over the SL. For example, if this time duration was set to 20 ms, the relay WTRU will send the RLC ACK over the SL even if it has not received an ACK for the RLC packet over the backhaul Uu, if 20 ms has elapsed after the packet was received over the SL. In one variant of this solution, the relay WTRU may include an additional flag/indication in the RLC ACK that it is sending to the remote WTRU upon the expiry of a time period, indicating to the remote WTRU that the RLC packet has not yet been received at the gNB.

In another example embodiment, the WTRU is configured with one maximum wait time value, and it is applied for every RLC packet of every RLC channel. In an alternative embodiment, the WTRU is configured with multiple maximum wait time values (e.g., a specific wait time value for each RLC channel). According to yet a further example embodiment, the relay WTRU may apply a different maximum wait time depending on the backhaul link quality and/or SL conditions/congestion or SL type (e.g., apply one wait time if the SL is PC5 interface and another wait time if the SL is another proprietary interface).

Procedures for a relay WTRU sending an additional indication of reception of RLC packets over the backhaul Uu are discussed herein. In one of these embodiments, the relay WTRU may send the RLC ACKs over the SL without waiting for their successful transmission over the Uu backhaul (i.e., as in legacy), but in addition to that it sends another indication to the remote WTRU regarding the reception of the corresponding RLC packets over the backhaul Uu.

In one solution, this indication of the successful or unsuccessful transmission over the backhaul Uu is sent in an RLC status PDU. For example, the legacy RLC status PDU can be enhanced or a new RLC status PDU can be specified, where it is implicitly or explicitly indicated that the RLC packet has also been received or not received at the gNB. In yet another embodiment, the relay WTRU simply forwards the RLC status PDUs that it is getting over the backhaul Uu from the gNB towards the remote WTRU.

The relay WTRU of another example, modifies the RLC status PDUs that it is getting over the backhaul Uu from the gNB before forwarding it to the remote WTRU . For example, the relay WTRU may change the RLC sequence numbers indicated in the status PDU from the gNB to the sequence numbers of the corresponding packets over the SL. This is specifically useful as the sequence numbers for an RLC packet over the SL and the backhaul Uu may not be the same. One such example is the case where the relay WTRU is relaying data for several WTRUs and the RLC channels over the backhaul Uu may be multiplexing data from several WTRUs.

In one example solution, the additional indication regarding the reception of the RLC packets over the Uu is sent to the remote WTRU via a signaling different from an RLC status PDU. For example, using a MAC CE, an SRAP control PDU, in a protocol header associated with data transmitted in the opposite direction, or on a physical channel resource (e.g. PSFCH). In certain embodiments, the relay WTRU applies one or more of the above behaviors (of sending information regarding the reception of the packets at the gNB) for all RLC packets, or the relay WTRU applies one or more of the above behaviors (of sending information regarding the reception of the packets at the gNB) only for some RLC channels (e.g., pre-configured by the gNB when the indirect path is setup).

In an alternate embodiment, the relay WTRU applies one or more of the above indications depending on the radio link conditions over the backhaul Uu or/and the radio link conditions (or congestion) over the SL towards the remote WTRU. For example, the relay WTRU may apply legacy behavior (i.e., no additional information about the reception of the packets at the gNB sent to the remote WTRU) when the backhaul Uu signal level is equal to or above a certain threshold and apply the new behavior when the backhaul Uu signal level is below the threshold. In one variant of the solution above, the relay WTRU may be configured to apply different signal level thresholds (e.g., for the backhaul Uu, for the SL, etc.) or congestion thresholds for the SL, for different RLC channels.

In some embodiments for multi-hop relaying, the relay WTRU may send an indication of successful transmission for a RLC PDU only if one of the following conditions is met: (i) the relay WTRU transmits directly to gNB and the RLC PDU was successfully transmitted; or (ii) the relay WTRU transmits to a second relay WTRU and receives an indication from second relay WTRU that the RLC PDU was successfully transmitted.

In some embodiments, the relay WTRU may buffer/store the RLC packets received over the SL and will delete them only when the corresponding RLC packet is successfully received at the gNB. According to another embodiment, the relay WTRU will determine if an RLC packet is one of the segments for a certain PDCP packet (e.g., by looking into the segmentation info and segment offset fields of the RLC packet header), and if so, will keep a SL RLC packet stored/buffer even if the corresponding RLC packet for that particular SL RLC packet was successfully received at the gNB, as long as any of the other related segments are still not received at the gNB. For example, assume a PDCP packet was segmented into 3 SL RLC packets at the remote WTRU, and 2 of the RLC packets have been successfully received at the gNB. The relay WTRU will keep all the 3 RLC packets until the 3rd RLC packet is also successfully received at the gNB.

In another embodiment, the relay WTRU will keep buffering the RLC packets, according to any of the solutions above, for a certain configured time period. For example, the relay WTRU may start a timer period whenever it receives an RLC packet over the SL, and it will delete the RLC packet if the time period expires before it has determined that the corresponding RLC packet over the Uu has not been successfully received at the gNB. For the case of RLC segmentation, the relay WTRU may start the time period upon receiving one of the RLC segments (e.g., the first segment, any intermediate or last segment if there was out of order reception), instead of starting the timer for each RLC segment. Alternatively, the relay WTRU may start the time period only upon receiving all the RLC segments of a certain PDCP PDU. In another example, the relay WTRU may adjust the time period duration value for keeping the SL RLC packets buffered depending on the radio link conditions over the backhaul Uu or/and the radio link conditions (or congestion) over the SL towards the remote WTRU. In one variant of the foregoing embodiments, the relay WTRU may be configured to apply different signal level thresholds for the SL/Uu and/or congestion thresholds for the SL and/or wait time values, for different RLC channels.

In certain embodiments, the remote WTRU, upon a HO and re-establishing the PDCP, will retransmit the PDCP PDU/SDUs that have not been indicated as being received by the gNB according to one of the previous embodiments (i.e., different from legacy behavior in that some packets that have already been ACKed over the SL, may be retransmitted towards the target).

In one example embodiment, the remote WTRU, upon a HO and re-establishing the PDCP, will retransmit all the PDCP PDU/SDUs that are in the transmission buffer (i.e., those with a discard time that has not yet expired), regardless of the reception status at the source relay WTRU (e.g., SL RLC ACKs) or indication regarding the reception status at the gNB according to one of the solutions above.

In another example, the remote WTRU adjusts the value of the discard time period to apply for PDCP packets depending on the backhaul Uu radio conditions (e.g., reported to the remote WTRU from the relay WTRU or the gNB) or/and the SL radio conditions or/and the SL congestion (e.g., CBR). For example, when the radio conditions over the backhaul are excellent, the discard timer can be shortened and when the radio conditions over the backhaul are bad, the discard time period can be lengthened.

The remote WTRU may be configured with a new timer (e.g., discard_timer_backhaul), which the WTRU starts running for each PDCP packet upon detecting the successful reception at the relay WTRU (e.g., indications from lower layers or RLC status PDUs from the relay WTRU, that indicate all the RLC packets corresponding to the PDCP packet has been received successfully at the relay WTRU). If the remote WTRU performs a HO and re-establishes the PDCP, it will retransmit all the PDCP packets that have this timer still running.

In one solution, the remote WTRU adjusts the value of this timer depending on the backhaul Uu radio conditions (e.g., reported to the remote WTRU from the relay WTRU or the gNB) or/and the SL radio conditions or/and the SL congestion (e.g., CBR). In another solution, the remote WTRU may stop the discard_timer_backhaul, if it receives an indication from the relay WTRU that indicates that the packet has been received properly at the gNB according to any of the solutions above (e.g., indication from the relay WTRU received indicating that all the RLC packets that correspond with the PDCP packet have been successfully received at the gNB). Alternatively, or in addition, if the PDCP discard timer expires even before the successful reception over the SL is determined, the remote WTRU may discard the packet.

Various embodiments may include, if the PDCP discard time period has not expired when the successful reception over the SL is determined, the remote WTRU may stop the discard timer and start a discard_timer_backhaul for that packet. Another embodiment might set the PDCP discard time period to infinity, or some practical equivalent of infinity, in order that the WTRU never deletes the packet until, for example: (i) it has got a status PDU from the gNB indicating proper reception of the packet; or (ii) WTRU has got an indication from the relay WTRU that the packet has been received at the gNB (e.g., indication from the relay WTRU received indicating that all the RLC packets that correspond with the PDCP packet have been successfully received at the gNB); or (iii) the discard_timer_backhaul that has been started upon the indication of successful reception at the relay WTRU has expired

Yet another example solution includes the remote WTRU, upon executing a HO, sending a request to the relay WTRU, indicating it to send any buffered SL RLC packets (e.g., buffered at the relay WTRU according to any of the solutions above). Upon the reception of these RLC packets, the remote WTRU is then able to extract the PDCP SDUs, re-encrypt and integrity protect using the security context associated with the target gNB, and retransmit them to the target.

In another embodiment, the relay WTRU may proactively send the buffered SL RLC packets to the remote WTRU without explicit request from the remote WTRU . For example, the relay WTRU, upon detecting a problem on the backhaul Uu link (e.g., RLF) or handover to another gNB, may send all the buffered SL RLC packets to the remote WTRU (e.g., along with an indication of the reason for doing so, e.g., indication of a HO, RLF, etc. ,). In one example, the remote WTRU may retransmit the PDCP SDUs extracted from these RLC packets when it later performs a HO or connection re-establishment (e.g., the indication of the RLF of the backhaul by the relay WTRU may trigger a CHO or a re-establishment at the remote WTRU).

A relay WTRU delaying the sending of Uu RLC ACKs until reception over the SL is discussed herein. In one embodiment, the relay WTRU may send an RLC ACK over the Uu only when the corresponding RLC packet is ACKed by the remote WTRU over the SL. In another embodiment, the relay WTRU applies this behavior for all RLC packets/channels. In another embodiment, the relay WTRU may send an RLC ACK over the Uu only for certain RLC channels (e.g., pre-configured by the gNB when the indirect path is setup).

In certain embodiments, the relay WTRU applies this behavior only for certain remote WTRUs (e.g., pre-configured by the gNB when the indirect path is setup, and remote WTRU identified at the SRAP level when the packet is received by the relay WTRU). In another solution, the relay WTRU applies this behavior depending on the radio link conditions over the backhaul Uu or/and the radio link conditions (or congestion) over the SL towards the remote WTRU. For example, the relay WTRU may apply legacy behavior (i.e., send the RLC ACKs over the Uu without waiting for their reception over the SL) when the SL radio link level is equal to or above a certain threshold OR/AND when the SL CBR is below a certain threshold. And the relay WTRU may apply the new behavior (i.e., wait until the reception over SL before sending the RLC ACKs over the Uu) when the SL radio link level is below a certain threshold OR/AND when the SL CBR is above a certain threshold. In one variant of these embodiments, the relay WTRU may be configured to apply different signal level thresholds (e.g., for the backhaul Uu, for the SL, etc.) or CBR thresholds for the SL, for different RLC channels. In another one variant, the relay WTRU may be configured to apply different signal level thresholds (e.g., for the backhaul Uu, for the SL, etc.) or CBR thresholds for the SL, for handling the ACKs of RLC packets destined for different remote WTRUs.

In some embodiments, the relay WTRU may be configured with a maximum time to wait for the ACKs over the SL before sending the RLC ACKs over the Uu. For example, if this time duration was set to 20 ms, the relay WTRU will send the RLC ACK over the Uu even if it has not received an ACK for the RLC packet over the SLu, if 20 ms has elapsed after the packet was received over the Uu. In one variant of this solution, the relay WTRU may include an additional flag/indication in the RLC ACK that it is sending to the gNB upon the expiry of the timer, indicating to the gNB that the RLC packet has not yet been received at the remote WTRU. In one embodiment, the relay WTRU is configured with one maximum wait time value, and it is applied for every RLC packet of every RLC channel. In another embodiment, the relay WTRU is configured with multiple maximum wait time values (e.g., a specific wait time value for each RLC channel).

In other embodiments, the wait time values can be remote WTRU specific. In one example, the relay WTRU may be configured with a specific wait time for each remote WTRU that it is serving (e.g., one specific value for each remote WTRU that is shared among all the SL RLC channels). In another example, the relay WTRU may be configured with multiple wait time for each remote WTRU, each corresponding to a particular RLC channel.

Relay WTRU Sending Additional Indication of Reception of RLC Packets Over the SL is discussed herein. According to one embodiment, the relay WTRU may send RLC ACKs over the Uu without waiting for their successful transmission over the SL (i.e., as in legacy), but in addition, it sends another indication to the gNB regarding the reception of the corresponding RLC packets over the SL. In certain embodiments, this indication of the successful or unsuccessful transmission over the SL is sent in an RLC status PDU. For example, the legacy RLC status PDU can be enhanced or a new RLC status PDU can be specified, where it is implicitly or explicitly indicated that the RLC packet has also been received or not received at the remote WTRU. In other embodiments, the relay WTRU simply forwards the RLC status PDUs that it is getting over the SL from the remote WTRU towards the gNB.

In certain embodiments, the relay WTRU modifies the RLC status PDUs that it is getting over the SL from the remote WTRU before forwarding it to the gNB. For example, the relay WTRU may change the RLC sequence numbers indicated in the status PDU from the WTRU to the sequence numbers of the corresponding packets over the Uu. This is specifically useful as the sequence numbers for an RLC packet over the Uu and the SL Uu may not be the same. One such example is the case where the relay WTRU is relaying data for several WTRUs and the RLC channels over the backhaul Uu may be multiplexing data from several WTRUs.

According to one example embodiment, the additional indication regarding the reception of the RLC packets over the SL is sent to the gNB via a signaling different from an RLC status PDU. For example, it could be: (i) a MAC CE; or (ii) an SRAP control PDU. In various embodiments, the relay WTRU applies one or more of the above behaviors (of sending information regarding the reception of the packets at the remote WTRU) for all RLC packets. Alternatively, the relay WTRU applies one or more of the above behaviors (of sending information regarding the reception of the packets at the remote WTRU) only for some RLC channels (e.g., pre-configured by the gNB when the indirect path is setup).

In one example embodiment, the relay WTRU sends information regarding the reception of the packets at the remote WTRU as mentioned in previous examples, only for some remote WTRUs (e.g., pre-configured by the gNB when the indirect path is setup, and remote WTRU identified at the SRAP level when the packet is received by the relay WTRU).

The relay WTRU send information regarding reception of packets at the remote WTRU, in an example embodiment, depending on the radio link conditions over the backhaul Uu or/and the radio link conditions (or congestion) over the SL towards the remote WTRU . For example, the relay WTRU may apply legacy behavior (i.e., no additional information about the reception of the packets at the remote WTRU sent to the gNB) when the SL radio link level is equal to or above a certain threshold OR/AND when the SL CBR is below a certain threshold. And the relay WTRU may apply the new behavior when the SL radio link level is below a certain threshold OR/AND when the SL CBR is above a certain threshold. In a modified example, the relay WTRU may be configured to send reception information by apply different signal level thresholds (e.g., for the backhaul Uu, for the SL, etc.) or CBR thresholds for the SL, for different RLC channels. In other examples, the relay WTRU may be configured to apply different signal level thresholds (e.g., for the backhaul Uu, for the SL, etc.) or CBR thresholds for the SL, for different remote WTRUs in determining whether to send additional information about the remote WTRU received packets.

For some embodiments of the present disclosure, the relay WTRU will buffer/store the RLC packets received over the Uu and will delete them only when the corresponding RLC packet is successfully received at the remote WTRU. In one example solution, the relay WTRU will determine if an RLC packet is one of the segments for a certain PDCP packet (e.g., by looking into the segmentation info and segment offset fields of the RLC packet header), and if so, will keep a Uu RLC packet stored/buffer even if the corresponding RLC packet for that particular RLC packet was successfully received at the remote WTRU, as long as any of the other related segments are still not received at the WTRU . For example, assume a PDCP packet was segmented into three Uu RLC packets at the gNB, and two of the RLC packets have been successfully received at the remote WTRU . The relay WTRU will keep all the three RLC packets until the 3rd RLC packet is also successfully received at the remote WTRU.

In another embodiment, the relay WTRU will keep buffering the RLC packets, according to any of the solutions above, for a certain configured time. For example, the relay WTRU may start a timer whenever it receives an RLC packet over the Uu, and it will delete the RLC packet if the timer expires before it has determined that the corresponding RLC packet over the SL has not been successfully received at the remote WTRU. For the case of RLC segmentation, the relay WTRU may start the timer upon receiving one of the RLC segments (e.g., the first segment, any intermediate or last segment if there was out of order reception), instead of starting the timer for each RLC segment. Alternatively, the relay WTRU may start the timer only upon receiving all the RLC segments of a certain PDCP PDU. In one variant of this solution, the relay WTRU may be configured to apply different signal level thresholds for the SL/Uu and/or congestion thresholds for the SL and/or wait time values, for different RLC channels. In another variant, the relay WTRU may be configured to apply different signal level thresholds for the SL/Uu and/or congestion thresholds for the SL and/or wait time values, for different remote WTRUs.

According to one embodiment, the relay WTRU may receive a request from the gNB to send any buffered Uu RLC packets (e.g., buffered at the relay WTRU according to any of the solutions above), and send them accordingly. In one solution, the request from the gNB for the buffered Uu RLC packets may include an indication of a remote WTRU identity (e.g., WTRU L2 ID), and the relay WTRU sends only those buffered RLC packets that are associated with the indicated WTRU.

In additional embodiments, activation/deactivation of the relay WTRU behavior are disclosed for preventing UL/DL packet loss during indirect to indirect/direct HO.

In various embodiments the sending of RLC ACKs over the SL is delayed until the corresponding RLC packet is successfully received at the gNB (for UL packets) or delaying the sending of RLC ACKs over the Uu is performed until the corresponding RLC packet is successfully received at the remote WTRU (for DL packets) to help ensure UL/DL packet loss will not happen when doing a HO from indirect to indirect/direct communication links. However, doing so pervasively may have undesirable results (e.g., increased RLC E2E delay causing increased RLC window size requirements and further leading to decrease in throughput).

There may be other drawbacks regarding the embodiments which modify the relay WTRU behavior described above. For example, sending a separate indication to the remote WTRU indicating reception at the gNB (or vice versa for DL packets) may cause unnecessary signaling during normal operation (i.e., not before/after a HO), on top of the potential problems of RLC window size and throughput mentioned above for the RLC ACK delaying case. For the embodiments where the relay WTRU does temporary buffering of SL RLC packets or Uu RLC packets for possible forwarding after a HO, there is the overhead of continuous storage of already ACKed packets at the relay WTRU.

Thus, it is desirable for embodiments that require modifications of behavior at the relay WTRU (e.g., delaying the RLC ACKs, sending of the separate indication acknowledging the reception over the next hop, temporary storage of properly ACKed packets for possible forwarding after a handover, etc.), only when necessary (e.g., in anticipation of a handover).

The following embodiments are described to that effect. In the embodiments below, focus is based on the delaying of RLC ACKs for the sake of brevity, but all the embodiments below are applicable to all the other solutions described herein.

In one embodiment, the relay WTRU may be configured to start the delaying of RLC ACKs (in the UL or DL direction) only upon the reception of an indication from the network. For example, the network may send the indication to the relay WTRU to start applying such behavior before the HO command is sent to the remote WTRU (e.g., a certain time before the network sends the HO command).

In another embodiment, the relay WTRU may be configured to apply the delaying of RLC ACKs (in the UL or DL direction) only upon the reception of an indication from the remote WTRU. For example, the remote WTRU may be configured with conditional handover (CHO) triggering conditions that have two thresholds, a first threshold to trigger the sending of the RLC delaying indication to the relay WTRU, and a second threshold to actually trigger the CHO towards a target. For example, if the CHO was based on condA3 (target>source+threshold), the first threshold could be a lower threshold than the second one (i.e., relay WTRU behavior triggered in anticipation of an upcoming CHO triggering).

For one example embodiment, a relay WTRU that has started applying the delaying of RLC ACKs upon the reception of an indication from the network, the relay WTRU may be configured to stop applying this behavior upon the reception of a subsequent indication from the network or the remote WTRU indicating to the relay WTRU to fall back to legacy operation of sending RLC ACKs that are dependent only on one hop.

In other embodiments, the relay WTRU may be configured to apply the delaying of RLC ACKs only for a certain configured duration after the reception of the indication from the network or the relay WTRU to start the delaying, and stop applying it afterwards (i.e., fall back to legacy behavior of sending the RLC ACKs without waiting for the corresponding ACK from the network). The duration may be included in the indication received from the network or WTRU, or configured separately.

Referring to FIG. 11, a method 1100 for triggering of PDCP retransmission upon reception of a status PDU after HO will be described. Method 1100 may generally begin after execution of handover 1105 of a remote WTRU from an indirect link with a source gNB to an indirect or direct link with a target gNB, e.g., after method 900 of FIG. 9 is completed). The remote WTRU receives 1110 a PDCP status PDU from the new gNB either over a direct link or an indirect link to the new gNB via another relay WTRU. If 1115, the PDCP status report received from the new gNB is the first PDCP status report from the new gNB (or/and the status report is received within a given time duration after the HO), the WTRU will retransmit 1120 all packets indicated as not received in PDCP status report, including previously transmitted packets that have been acknowledged as received from lower layers (e.g., an indication received from the source relay WTRU before the HO). If 1115, the PDCP status report received from the new gNB is not the first, e.g., a second, third, etc., PDCP status report (or the report was received after a given time duration has elapsed after the HO), then the WTRU will retransmit 1125 packets, if any, indicated as not received in the PDCP status report, excluding previously transmitted packets acknowledged as received by lower layers.

Reception of status PDUs in legacy operation is used by the WTRU PDCP transmit entity only to determine whether a PDCP SDU is to be discarded or not, even before a discard timer has expired, and as such no transmit action is taken by the remote WTRU for those PDUs indicated as not received. Thus, in these embodiments a retransmission behavior is introduced at the PDCP (similar to RLC ARQ), but that is triggered only after a HO (e.g., step 1105 of FIG. 11). Additionally, it should be noted that like some of the embodiments above, the WTRU also retransmits a packet even if it was ACKed at lower layers (1120 of FIG. 11), as long as the PDCP SDU for the corresponding packet is still available at the transmit buffer (i.e., discard timer for the packet has not expired).

In one variant of the above embodiment, the WTRU applies the above behavior (i.e., retransmit ACKed packets in WTRU PDCP buffer indicated as not received the PDCP status PDU from the new eNB), only on the reception of the first PDCP status PDU after a HO (e.g., a handover from indirect link to a direct/indirect link). In another embodiment, the WTRU applies the above behavior only if the PDCP status was received within a given configured duration after the HO.

According to certain embodiments, the WTRU applies the above behavior on the reception of a PDCP status that has an explicit indication (e.g., a flag in the packet header, a status PDU using a new PDU format, etc.,) indicating to the WTRU to retransmit the packets indicated as not received by the network. It should be recognized that the foregoing embodiments may also be applicable in the DL direction. For example, the remote WTRU sending a PDCP status PDU after a HO that indicates to the network to retransmit the packets indicated as not received properly.

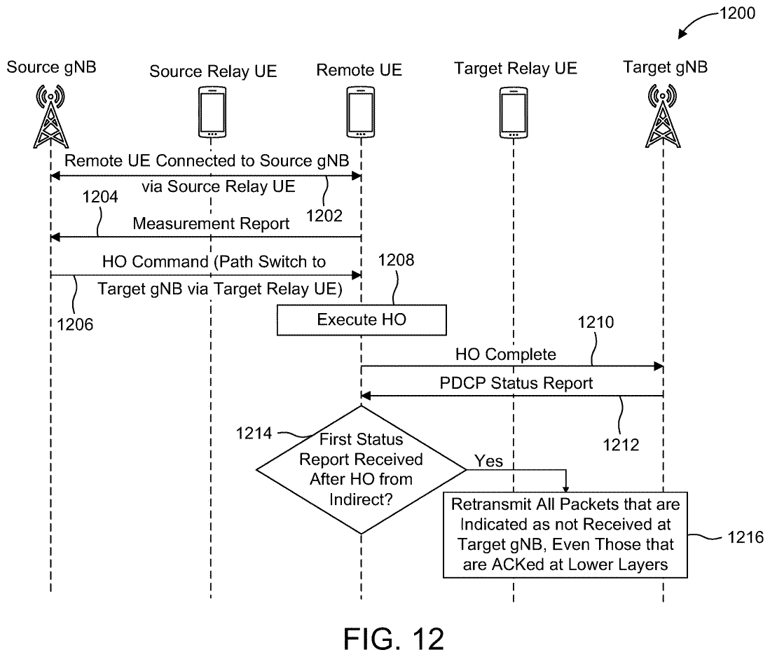

Turning to FIG. 12, a message sequence diagram 1200 is shown detailing a related embodiment. In FIG. 12, a remote WTRU is connected 1202 to a source gNB, via a source relay WTRU. The remote WTRU sends 1204 a measurement report to source gNB which determines a handover should be performed and sends 1206 a HO command (e.g., a path switch to target gNB via target relay WTRU). At 1208, the remote WTRU executes a HO to target gNB, e.g., by any of the processes previously discussed. When the remote WTRU sends 1210 a HO complete message to the target gNB via target relay WTRU, the target gNB sends 1212 a PDCP status report to the remote WTRU. If 1214 the PDCP status report is the first report received after the handover from the indirect link with the source relay WTRU, then the remote WTRU retransmits 1216 all packets in its buffer that are indicated as not received at the target gNB, even those that are ACKed at lower layers.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for a wireless transmit receive unit (WTRU), the method comprising:
executing a handover (HO) from an indirect link to a source base station via a source relay WTRU to a direct or indirect link with a target base station,
receiving a packet data convergence protocol (PDCP) status report from the target base station after the handover; and
retransmitting PDCP packets in the WTRU's PDCP buffer indicated as not received in the received PDCP status report, wherein retransmitting PDCP packets in the WTRU's PDCP buffer include PDCP packets previously transmitted to, and reception of which acknowledged by, the source relay WTRU.

2. (canceled)

3. The method of claim 1, wherein retransmitting the PDCP packets is performed only on reception of a first PDCP status report from the target base station after the HO or when the PDCP status report was received within a configured duration after the HO.

4. The method of claim 1, wherein retransmitting the PDCP packets is initiated by an explicit indicator present in the received PDCP status report.

5. The method of claim 1, wherein the HO is to the indirect link with the target base station facilitated by a target relay WTRU.

6. The method of claim 1, wherein the received PDCP status report comprises a PDCP status PDU from the target base station either over a direct link or an indirect link with the target base station via a target relay WTRU.

7. The method of claim 1, further comprising:
extending one or more discard timers of PDCP packets in the WTRU's PDCP buffer after the HO.

8. A wireless transmit receive unit (WTRU) comprising:
a transceiver, a PDCP buffer and a processor in communication with to the transceiver and PDCP buffer, the transceiver and processor configured to:
execute a handover (HO) from an indirect link with a source relay WTRU to a direct or indirect link with a target base station,
receive a packet data convergence protocol (PDCP) status report from the target base station after the handover; and
retransmit PDCP packets in the PDCP buffer indicated as not received in the received PDCP status report, wherein retransmitting PDCP packets in the WTRU's PDCP buffer include PDCP packets previously transmitted to, and reception of which acknowledged by, the source relay WTRU.

9. (canceled)

10. The WTRU of claim 8, wherein the retransmission of PDCP packets is performed only on reception of a first PDCP status report from the target base station after the HO or when the PDCP status report was received within a configured duration after the HO.

11. The WTRU of claim 8, wherein the retransmission of PDCP packets is initiated by an explicit indicator present in the received PDCP status report.

12. The WTRU of claim 8, wherein the HO is to the indirect link with the target base station facilitated by a target relay WTRU.

13. The WTRU of claim 8, wherein the received PDCP status report comprises a PDCP status PDU from the target base station either over a direct link or an indirect link with the target base station via a target relay WTRU.

14. The WTRU of claim 8, wherein the processor is further configured to extend one or more discard timers of PDCP packets in the WTRU's PDCP buffer after the HO.
